(19) United States
(12) Patent Application Publication
(10) Pub. No.: US 2009/0219733 A1
(43) Pub. Date: Sep. 3, 2009

(54) ELECTRONIC DEVICE HAVING LIGHT GUIDE

(75) Inventors: KUN-CHIH HSIEH, Tu-Cheng (TW); JIAN-QIANG ZHAO, Shenzhen City (CN); WEN-HSING LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/344,577

(22) Filed: Dec. 28, 2008

(30) Foreign Application Priority Data
Feb. 29, 2008 (CN) 200810065467.9

(51) Int. Cl. F21V 7/04

(52) U.S. Cl. 362/613; 362/627

(57) ABSTRACT

An electronic device includes a panel, a light guide, and light sources. The panel defines a light area, and includes a transparent main body, an optical clear coating layer painted on the main body, and a light tight coating layer painted on the optical clear coating layer without covering the light area. The light guide is disposed beneath the panel. The light guide fills up the whole light area. The light sources are configured for illuminating the light guide.

### BACKGROUND

1. Technical Field

The disclosure relates to an electronic device and, particularly, to an electronic device which has a light guide for providing uniform illumination.

2. General Background

Electronic devices usually adopt light sources for generating light. For example, FIG. 4 shows an electronic device. The electronic device is a keypad. The keypad includes a transparent main body 1, an optically clear coating layer 2 painted on the main body 1, a light tight coating layer 3 painted on the optically clear layer 2, and a light source beneath the main body 1. The light tight coating layer 3 defines areas in the shape of characters or icons without light tight coating. The light source backlights the characters or icons so that the keypad can be used even in low ambient light conditions.

However, the light source has a directional characteristic. That is, light emitted by the light source is transmitted directionally. If the light source needs to illuminate a large area, light may not evenly illuminate the entire area.

Thus, what is needed is an electronic device exhibiting even light effect.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an schematic, front view of an electronic device according to an exemplary embodiment.

FIG. 2 is an enlarged, partial section view taken along A-A direction of FIG. 1, showing a panel, a base plate, a light guide, and light sources.

FIG. 3 is an enlarged, front view of the electronic device of FIG. 2, with the panel removed.

FIG. 4 is a schematic, isometric view of a related-art electronic device.

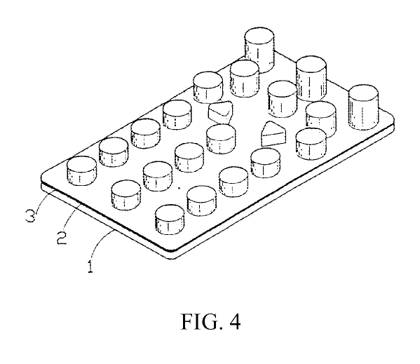

### DETAILED DESCRIPTION OF THE EMBODIMENTS

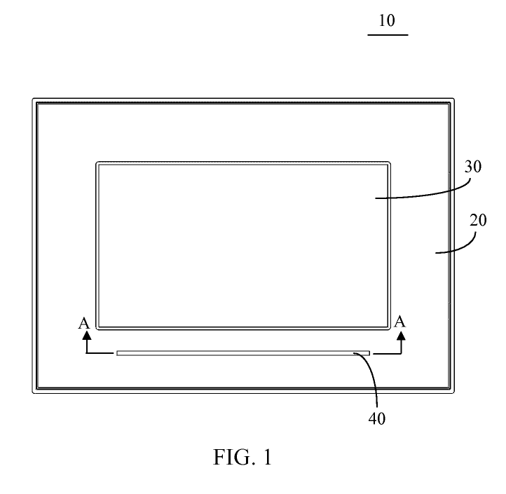

Referring to FIG. 1, an electronic device is disclosed. The electronic device 10 is, as an example, a digital photo frame. The photo frame 10 includes a panel 20 and a display 30 mounted on the panel 20. The panel 20 defines a light area 40. The light area 40 is strip-shaped and normally unlit.

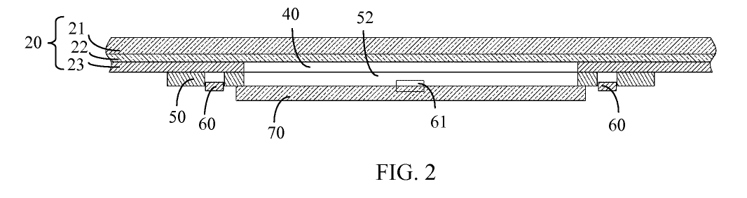

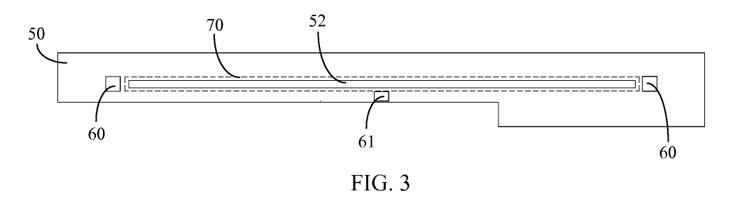

Referring to FIGS. 2 and 3, the panel 20 includes a transparent main body 21, an optical clear coating layer 22, and a light tight coating layer 23. The optical clear coating layer 22 is painted on the main body 21. The light tight coating layer 23 is painted on the optical clear coating layer 22 without covering the light area 40.

The electronic device 10 further includes a light guide 70 beneath the panel 20 configured for filling up the whole light area 40, and light sources 60 for illuminating the light guide 70. In this embodiment, the electronic device 10 further includes a base plate 50 disposed between the panel 20 and the light guide 70.

The base plate 50 defines an opening 52 corresponding to the light area 40. The light guide 70 is made of transparent material or semi-transparent material. The light guide 70 covers the opening 52. Light sources 60, 61 are mounted on the base plate 50. The number and types of the light sources 60, 61 can be changed if necessary. In this embodiment, the light sources 60 are two light emitting diodes (LED) which are capable of emitting unidirectional light. The light sources 60 are mounted adjacent to two ends of the light guide 70. The light source 61 is an LED capable of emitting light over a large angle. The light source 61 is mounted adjacent to a middle part of the light guide 70.

When having been turned on, the light sources 60, 61 emit light towards the light guide 70. The emitted light is mixed in the light guide 70 and the light guide 70 is evenly lighted. Based on the light area 40 and the opening 52, the evenly lighted light guide 70 can be seen out of the electronic device 10. In this way, the light area 40 of the electronic device 10 is evenly lit.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An electronic device comprising:
a panel defining a light area, comprising:
a transparent main body;
an optical clear coating layer painted on the main body; and
a light tight coating layer painted on the optical clear coating layer without covering the light area;
a light guide beneath the panel configured for filling up the whole light area; and
a plurality of light sources configured for illuminating the light guide.

2. The electronic device of claim 1, further comprising a base plate disposed between the panel and the light guide, wherein the base plate defines an opening corresponding to the light area.

3. The electronic device of claim 1, wherein the light area is strip-shaped.

4. The electronic device of claim 1, wherein the plurality of light sources are a plurality of light emitting diodes.

5. The electronic device of claim 4, wherein the plurality of LEDS comprise two LED which emit unidirectional light and a LED which emits large angle light, the two LED which emit unidirectional light are mounted adjacent to two ends of the light guide, respectively, and the LED which emits large angle light is mounted adjacent to a middle part of the light guide.

6. The electronic device of claim 1, wherein the light guide is made of transparent material or semi-transparent material.
